(19) United States
(12) Patent Application Publication
(10) Pub. No.: US 2024/0220569 A1
(43) Pub. Date: Jul. 4, 2024

(54) OPTIMIZATION APPARATUS, OPTIMIZATION METHOD, AND PROGRAM

(71) Applicant: NIPPON TELEGRAPH AND TELEPHONE CORPORATION, Tokyo (JP)

(72) Inventors: Satoshi HASEGAWA, Tokyo (JP); Takayuki MIURA, Tokyo (JP)

(21) Appl. No.: 18/555,096

(22) PCT Filed: Apr. 27, 2021
(86) PCT No.: PCT/JP2021/016783

§ 371 Date: Oct. 12, 2023

(51) Int. Cl. G06F 17/11

(52) U.S. Cl. CPC G06F 17/11

(57) ABSTRACT

An optimization apparatus according to one embodiment is an optimization apparatus for optimizing a function having a parameter is provided. The optimization apparatus comprises: a sub-sampling unit that randomly samples a predetermined number of pieces of data from a given data set, to create a data aggregate consisting of the predetermined number of pieces of data; a gradient calculation unit that calculates a gradient related to the parameter of a l-Lipschitz continuous loss function, for each of the pieces of data included in the data aggregate; a noise addition unit that adds noise according to a Gaussian distribution to the gradient to calculate a gradient after noise addition; and a parameter update unit that updates the parameter by using the gradient obtained after the noise addition.

### TECHNICAL FIELD

The present invention relates to an optimization apparatus, an optimization method, and a program.

### BACKGROUND ART

As a method for protecting privacy of data used during training from output results of machine learning, a standard called differential privacy is often used. As a method for realizing the differential private machine learning, a differentially private stochastic gradient descent (hereinafter referred to as DP-SGD) applicable to deep learning as well has been widely used (for example, NPL 1).

In the DP-SGD, a certain restriction is provided to the L2 norm of the gradient used in the calculation of the SGD (stochastic gradient descent method), and noise following the Gaussian distribution is given to the gradient, thereby guaranteeing differential privacy. In this case, in NPL 1, a method of clipping the calculated gradient is used as a way of providing a restriction to the L2 norm of the gradient.

### CITATION LIST

### Non Patent Literature

[NPL 1] Martin Abadi, Andy Chu, Ian Goodfellow, H Brendan McMahan, Ilya Mironov, Kunal Talwar, and Li Zhang. Deep learning with differential privacy. In Proceedings of the 2016 ACM SIGSAC conference on computer and communications security, pp. 308-318, 2016.

### SUMMARY OF INVENTION

### Technical Problem

However, in NPL 1, since it is necessary to calculate the norm of the gradient for each piece of data when clipping the gradient, calculation may take time.

An embodiment of the present invention was made in view of the above points, and an object of the present invention is to reduce the calculation time of DP-SGD.

### Solution to Problem

In order to achieve the object, an optimization apparatus according to one embodiment is an optimization apparatus for optimizing a function having a parameter, the optimization apparatus comprising: a sub-sampling unit that randomly samples a predetermined number of pieces of data from a given data set, to create a data aggregate consisting of the predetermined number of pieces of data; a gradient calculation unit that calculates a gradient related to the parameter of a l-Lipschitz continuous loss function, for each of the pieces of data included in the data aggregate; a noise addition unit that adds noise according to a Gaussian distribution to the gradient to calculate a gradient after noise addition; and a parameter update unit that updates the parameter by using the gradient obtained after the noise addition.

### Advantageous Effects of Invention

The calculation time of DP-SGD can be reduced.

### BRIEF DESCRIPTION OF DRAWINGS

FIG. 1 is a diagram showing an example of a hardware configuration of a private optimization apparatus according to the present embodiment.

FIG. 2 is a diagram showing an example of a functional configuration of the private optimization apparatus according to the present embodiment.

FIG. 3 is a flowchart showing an example of a flow of private optimization processing according to the present embodiment.

### DESCRIPTION OF EMBODIMENTS

An embodiment of the present invention will be described below. In the present embodiment, gradient clipping is not required, so that a DP-SGD which can be calculated at a high speed (hereinafter referred to as a high-speed DP-SGD) can be obtained, and a private optimization apparatus 10 for executing this high-speed DP-SGD will be described. Since the high-speed DP-SGD does not require gradient clipping, each gradient to which noise is added can be calculated in parallel, and the calculation time can be reduced more than the conventional DP-SGD.

### Definitions of Reference Symbols

The input is defined as a d-dimensional real vector x∈R^{d}, and the output is defined as a real number y∈R. The goal of machine learning is to determine a parameter θ of a function f:R^{d}→R such that a loss function L(f(x; θ), y) is the smallest from a data set D={(xᵢ, yᵢ)|i=1, . . . , N} consisting of N input/output pairs. In other words, the following is obtained.

$$∀ x , y , {min}_{θ} ℒ ( f ( x , θ ) , y ) \qquad [ Math . 1 ]$$

In the following description, the input/output pairs (xᵢ, yᵢ) constituting the data set D are also referred to as records. There is an SGD (stochastic gradient descent method) as a calculation method for the above equation 1, and θ is determined for each t by repeating the following steps.

$${θ}_{t + 1} ← {θ}_{t} - α ∇ L ( f ( {x}_{i} ; θ ) , {y}_{i} )$$

where α is a learning constant.

It should be noted that there is an approach called a mini-batch gradient descent method as a method of utilizing not only one piece of data but also a plurality of pieces of data for calculating the loss function L. In the following, it is assumed that the mini-batch gradient descent method and the stochastic gradient descent method are not particularly distinguished.

### <Conventional DP-SGD>

In the conventional DP-SGD, the following steps are performed at each iteration number t (also referred to as timing).

Sub-sampling: At timing t, S (<N) records are extracted from the data set D by random sampling, and an aggregate of the extracted records is taken as Sₜ={(xᵢ, yᵢ)|i=1, . . . , S}.

Calculation of gradient: For each i=1, . . . , S, the gradient gₜ(xᵢ, yᵢ) at the timing t is obtained as follows.

$${g}_{t} ( {x}_{i} , {y}_{i} ) ← {∇}_{{θ}_{t}} ℒ ( f ( {x}_{i} , {θ}_{t} ) , {y}_{i} ) \qquad [ Math . 2 ]$$

Here, θₜ is a parameter θ at the timing t.

Clipping of gradient: Clipping of the gradient is performed for each i=1, . . . , S as follows.

$${g}_{t} ( {x}_{i} , {y}_{i} ) ← {g}_{t} ( {x}_{i} , {y}_{i} ) / max ( 1 , \frac{{‖ {g}_{t} ( {x}_{i} , {y}_{i} ) ‖}_{2}}{C} ) \qquad [ Math . 3 ]$$

Noise addition: Noise is added in the following manner, to calculate the gradient ∇Lₜ at the timing t.

$$∇ {ℒ}_{t} = \frac{1}{S} ( {\sum }_{i} {g}_{t} ( {x}_{i} , {y}_{i} ) + N ( 0 , {σ}^{2} {C}^{2} I ) ) \qquad [ Math . 4 ]$$

In this case, the parameter is defined as C∈R₊, a unit matrix is defined as I, and a Gaussian distribution is defined as N(⋅, ⋅). As described above, the calculation of the gradient clipping must be individually performed for each i=1, . . . , S. That is, the calculation of the gradient clipping is the bottleneck in parallel calculation.

Parameter update: The parameter is updated by θₜ₊₁←θₜ−α∇Lₜ.

### <High-Speed DP-SGD>

The high-speed DP-SGD proposed in the present embodiment will be described. In the high-speed DP-SGD, the L2 norm of the gradient is naturally suppressed to a constant value or less, thereby eliminating the need for gradient clipping. For this purpose, the loss function L is set to be l-Lipschitz continuous (1 is the lowercase L).

When the loss function L is l-Lipschitz continuous, then this loss function L has the following properties.

$$‖ {∇}_{{θ}_{t}} ℒ ( f ( {x}_{i} ; {θ}_{t} ) , {y}_{i} ) ‖ \leq l \qquad [ Math . 5 ]$$

Thus, since the norm of the gradient is limited to 1, it is not necessary to perform clipping at a constant C in the high-speed DP-SGD, and only noise is added.

### <<Specific Example of High-Speed DP-SGD>>

The following describes an example where the function f is made l=l-Lipschitz continuous by applying spectral normalization, to constitute a high-speed DP-SGD. Here, it is assumed that the function f is a deep neural network (DNN) applied to a task such as a classification problem. For the spectral normalization, for example, the reference literature “Takeru Miyato, Toshiki Kataoka, Masanori Koyama, and Yuichi Yoshida. Spectral normalization for generative adversarial networks. In International Conference on Learning Representations, 2018.” and the like should be referred to.

### Lipschitz Continuity of DNN

The DNN is composed of a combination of the weight of layers {W⁽ⁱ⁾|i=1, . . . , K} and the (non) linear function {(φ⁽ⁱ⁾|i=1, . . . , K}. Here, φ⁽ⁱ⁾ is also referred to as an activation function.

Specifically, the function f representing the DNN is constructed as follows.

$$f ( x ) = {φ}^{( K )} ( {W}^{( K )} ( {φ}^{( K - 1 )} ( {W}^{( K - 1 )} … {φ}^{( 1 )} ( {W}^{( 1 )} ( x ) ) ) ) )$$

where K is the number of layers, and W⁽ⁱ⁾ is a matrix (weight matrix) representing the weight of i layer. In addition, examples of φ⁽ⁱ⁾ (where i=1, . . . , K−1) include ReLu and Leaky ReLu. Examples of φ^{(K}) include tanh, sigmoid, and softmax. In the following description, the output of the i-th layer is x⁽ⁱ⁺¹⁾=φ⁽ⁱ⁾(W⁽ⁱ⁾(x⁽ⁱ⁾).

Since the function f is l-Lipschitz continuous, it is sufficient if the L2 norm of the input of the i layer is suppressed to 1, that is, if the L2 norm of the input x^{(I)} of the i layer is ∥x⁽ⁱ⁾∥₂: <1. However, as the (non) linear function φ^{(I)} (where i=1, . . . , K−1), the present invention is limited to a l-Lipschitz continuous function such as ReLu and Leak ReLu.

In order to suppress the L2 norm of x^{(I)} to 1, x′⁽ⁱ⁾=x⁽ⁱ⁾/∥x⁽ⁱ⁾∥₂ may be used.

Therefore, by using x′⁽ⁱ⁾ instead of x⁽ⁱ⁾ and configuring the function f representing DNN as follows, a l-Lipschitz continuous function can be obtained.

$$f ( {x}^{′} ) = {φ}^{( K )} ( {W}^{( K )} ( {φ}^{( K - 1 )} ( {W}^{( K - 1 )} … {φ}^{( 1 )} ( {W}^{( 1 )} ( {x}^{′} ) ) ) ) )$$

When processing in batches, since x is a matrix, it is sufficient if the spectral norm is suppressed to 1. That is, in this case, with ∥⋅∥ as the spectral norm, x′⁽ⁱ⁾=x⁽ⁱ⁾/∥x⁽ⁱ⁾∥ may be used. The spectral norm can be calculated at high speed by using a power law or other methods.

Lipschitz continuity of nonlinear function of final layer φ^{(K}) is a nonlinear function of the final layer, which is different from ReLu, Leak ReLu, and the like because it returns the output of the DNN. In the classification problem, tanh, sigmoid, softmax and the like are used as φ^{(K)}, and they are all l-Lipschitz continuous functions.

### Lipschitz Continuity of Loss Functions

It is assumed that the function f representing the DNN is l-Lipschitz continuous. In this case, for example, by using L2Los, L1Los and HingLoss as the loss function L, the loss function L becomes l-Lipschitz continuous. Since the cross entropy is not l-Lipschitz continuous, the cross entropy cannot be set as the loss function L.

Thus, since the loss function L becomes l-Lipschitz continuous,

$${‖ {∇}_{{θ}_{t}} ℒ ‖}_{2} \leq 1 \qquad [ Math . 6 ]$$

The above equation is guaranteed. Therefore, since gradient clipping is not required, the calculation time can be reduced more than the conventional DP-SGD, by calculating in parallel the gradient to which noise is to be added. In this configuration example, the DNN is assumed as the function f, but this is merely an example, and any function can be used as long as the loss function L is l-Lipschitz continuous.

### <<Algorithm of High-Speed DP-SGD>>

The algorithm of the high-speed DP-SGD at the iteration number t (timing t) will be described below. In the high-speed DP-SGD, the following steps are executed for each iteration number t.

Sub-sampling: At timing t, S (<N) records are extracted from the data set D by random sampling, and an aggregate of the extracted records is taken as Sₜ={(xᵢ, yᵢ)|i=1, . . . , S}.

Calculation of gradient: For each i=1, . . . , S, the gradient gₜ(xᵢ, yᵢ) at the timing t is obtained as follows.

$${g}_{t} ( {x}_{i} , {y}_{i} ) ← {∇}_{{θ}_{t}} ℒ ( f ( {x}_{i} , {θ}_{t} ) , {y}_{i} ) \qquad [ Math . 7 ]$$

Noise addition: Noise is added in the following manner, to calculate the gradient ∇Lₜ at the timing t.

$$∇ {ℒ}_{t} = \frac{1}{S} ( {\sum }_{i} {g}_{t} ( {x}_{i} , {y}_{i} ) + N ( 0 , {σ}^{2} I ) ) \qquad [ Math . 8 ]$$

Parameter update: The parameter is updated by θₜ₊₁←θₜ−α∇Lₜ.

### <Hardware Configuration of Private Optimization Apparatus 10>

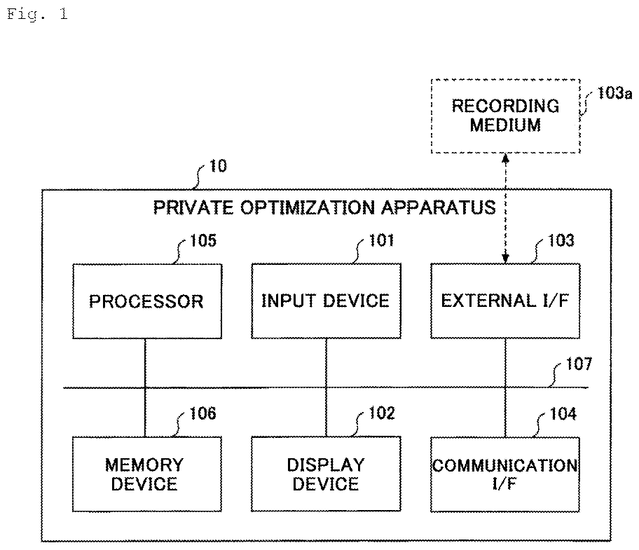

Next, a hardware configuration of the private optimization apparatus 10 according to the present embodiment will be described with reference to FIG. 1. FIG. 1 is a diagram showing an example of the hardware configuration of the private optimization apparatus 10 according to the present embodiment.

As illustrated in FIG. 1, the private optimization apparatus 10 according to the present embodiment is implemented by a hardware configuration of a general computer or a computer system and includes an input device 101, a display device 102, an external I/F 103, a communication I/F 104, a processor 105, and a memory device 106. Each of these hardware components is communicatively connected via a bus 107.

The input device 101 is, for example, a keyboard, a mouse, a touch panel, or the like. The display device 102 is, for example, a display or the like. The private optimization apparatus 10 may not include, for example, at least one of the input device 101 and the display device 102.

The external I/F 103 is an interface with an external device such as a recording medium 103a. The private optimization apparatus 10 can read from and write to the recording medium 103a via the external I/F 103. Examples of the recording medium 103a include a CD (compact disc), a DVD (digital versatile disk), an SD (secure digital) memory card, a USB (universal serial bus) memory card, and the like.

The communication I/F 104 is an interface for connecting the private optimization apparatus 10 to a communication network. The processor 105 is, for example, various arithmetic devices such as a CPU (central processing unit) and a GPU (graphics processing unit). The memory device 106 is, for example, various storage devices such as a HDD (hard disk drive), an SSD (solid state drive), a RAM (random access memory), a ROM (read only memory), and a flash memory.

By having the hardware configuration shown in FIG. 1, the private optimization apparatus 10 according to the present embodiment can implement the above-described private optimization processing. Note that the hardware configuration shown in FIG. 1 is merely an example, and the private optimization apparatus 10 may have another hardware configuration. For example, the private optimization apparatus 10 may include a plurality of processors 105, or may include a plurality of memory devices 106.

### <Functional Configuration of Private Optimization Apparatus 10>

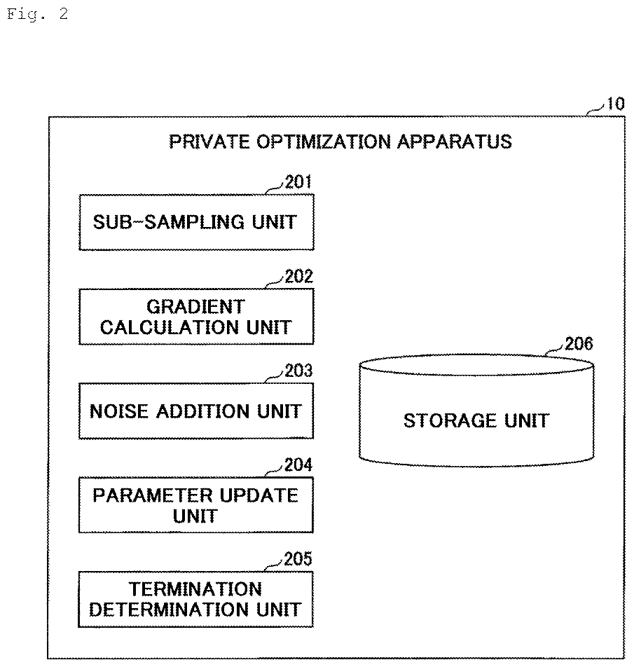

Next, a functional configuration of a private optimization apparatus 10 according to the present embodiment will be described with reference to FIG. 2. FIG. 2 is a diagram showing an example of a functional configuration of the private optimization apparatus 10 according to the present embodiment.

As shown in FIG. 2, the private optimization apparatus 10 according to the present embodiment includes a sub-sampling unit 201, a gradient calculation unit 202, a noise addition unit 203, a parameter update unit 204, and a termination determination unit 205. Each of these units is implemented by, for example, processing that one or more programs installed in the private optimization apparatus 10 cause the processor 105 to execute.

The private optimization apparatus 10 according to the present embodiment includes a storage unit 206. The storage unit 206 is implemented by, for example, the memory device 106. Note that the storage unit 206 may be implemented by using, for example, a storage device connected to the private optimization apparatus 10 via a communication network or the like.

The sub-sampling unit 201 extracts S (<N) records from the data set D by random sampling at each timing t, to create Sₜ={((xᵢ, yᵢ)|i=1, . . . , S}.

The gradient calculation unit 202 calculates the gradient gₜ(xᵢ, yᵢ) at the timing t for each i=1, . . . , S.

The noise addition unit 203 calculates the gradient ∇Lₜ at the timing t by adding noise according to the Gaussian distribution to the gradient gₜ(xᵢ, yᵢ).

The parameter update unit 204 updates the parameter by θₜ₊₁←θₜ−α∇Lₜ.

The termination determination unit 205 determines whether or not to terminate the iteration with respect to t.

The storage unit 206 stores various pieces of data (for example, the data set D, various parameters, etc.) necessary for executing the high-speed DP-SGD.

### <Flow of Private Optimization Processing>

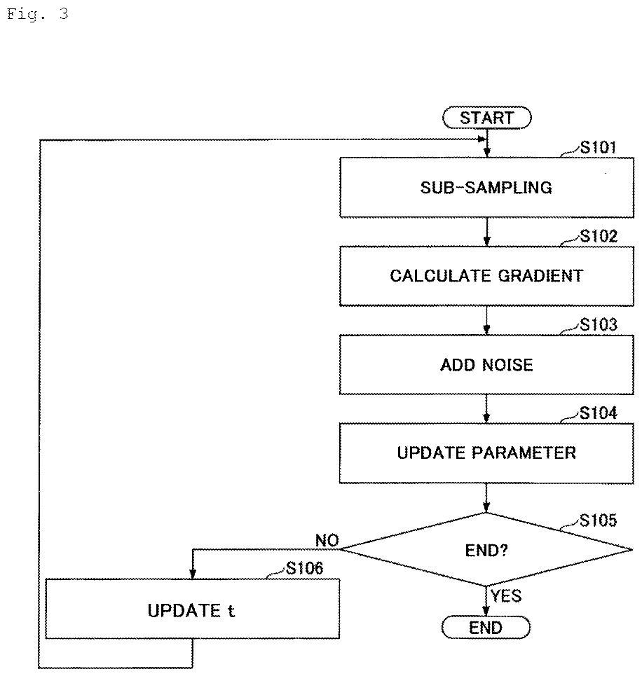

The flow of the private optimization processing for learning the parameter θ of a function f (x; θ) by the high-speed DP-SGD will be described below with reference to FIG. 3. FIG. 3 is a flowchart showing an example of the flow of the private optimization processing according to the present embodiment.

The flow of the private optimization processing for a certain t (where t is an integer equal to or greater than 0) will be described below. It is assumed that a parameter θ₀ at t=0 is initialized by an arbitrary method.

First, the sub-sampling unit 201 extracts S (<N) records from the data set D by random sampling, to create Sₜ={(xᵢ, yᵢ)|i=1, . . . , S} (step S101).

Then, the gradient calculation unit 202 calculates, for each i=1, . . . , S, the gradient gₜ(xᵢ, yᵢ) is calculated by the above equation 7 (step S102). As described above, the loss function L is l-Lipschitz continuous (in particular, l=l-Lipschitz continuous).

Next, the noise addition unit 203 adds noise to the gradient gₜ(xᵢ, yᵢ) according to the above equation 8, to calculate the gradient ∇Lₜ (step S103).

Then, the parameter update unit 204 updates the parameter by θₜ₊₁←θₜ−α∇Lₜ (step S104).

The termination determination unit 205 determines whether or not to terminate the iteration with respect to t (step S105). Here, the termination determination unit 205 may determine to terminate the iteration with respect to t when a predetermined termination condition is satisfied, and may determine not to terminate the iteration with respect to t when the termination condition is not satisfied. Note that such termination condition is, for example, that the number of iterations with respect to t reaches a predetermined number T, that the parameter θ converges, and the like.

When it is determined in step S105 that the iteration with respect to t is not finished, the termination determination unit 205 updates such that t←t+1 (step S106), and returns to step S101. In this manner, steps S101 to S104 described above are repeatedly executed with respect to each t.

On the other hand, when it is determined in step S105 that the iteration with respect to t is finished, the private optimization apparatus 10 ends the private optimization processing. In this case, the finally obtained parameter θₜ is a learned parameter.

### CONCLUSION

As described above, the private optimization apparatus 10 according to the present embodiment can learn the parameter θ of the function f by the DP-SGD which does not require gradient clipping. Thus, since the gradient gₜ(xᵢ, yᵢ) to which noise is to be added can be calculated in parallel (in other words, it is not necessary to perform gradient clipping for each (xᵢ, yᵢ) after the gradient gₜ(xᵢ, yᵢ) is calculated in parallel), the parameter θ of the function f can be learned at high speed. As is apparent from the above equation 8, the high-speed DP-SGD guarantees the differential privacy as in the conventional DP-SGD.

The present invention is not limited to the specifically disclosed embodiments, and various modifications, changes, combinations with known techniques, and the like can be made without departing from the scope of the claims.

### REFERENCE SIGNS LIST

10 Private optimization apparatus
101 Input device
102 Display device
103 External I/F
103a Recording medium
104 Communication I/F
105 Processor
106 Memory device
107 Bus
201 Sub-sampling unit
202 Gradient calculation unit
203 Noise addition unit
204 Parameter update unit
205 Termination determination unit
206 Storage unit

1. An optimization apparatus for optimizing a function having a parameter, the optimization apparatus comprising:
a processor; and
a memory storing program instructions that cause the processor to:
randomly sample a predetermined number of pieces of data from a given data set, to create a data aggregate consisting of the predetermined number of pieces of data;
calculate a gradient related to the parameter of a l-Lipschitz continuous loss function, for each of the pieces of data included in the data aggregate;
add noise according to a Gaussian distribution to the gradient to calculate a gradient after noise addition; and
update the parameter by using the gradient obtained after the noise addition.

2. The optimization apparatus according to claim 1, wherein the function having the parameter is a l-Lipschitz continuous function representing a neural network in which an L2 norm or a spectral norm of an input of each layer is less than 1 and an activation function of each layer other than a final layer is ReLU or Leaky ReLU, and the loss function is a l-Lipschitz continuous function of any of L2Loss, L1Loss, and HingeLoss.

3. The optimization apparatus according to claim 2, wherein the activation function of the final layer of the neural network is a l-Lipschitz continuous function of any of tanh, sigmoid, and softmax.

4. An optimization method executed by a computer for optimizing a function having a parameter, the optimization method comprising:
randomly sampling a predetermined number of pieces of data from a given data set, to create a data aggregate consisting of the predetermined number of pieces of data;
calculating a gradient related to the parameter of a l-Lipschitz continuous loss function, for each of the pieces of data included in the data aggregate;
adding noise according to a Gaussian distribution to the gradient to calculate a gradient after noise addition; and
updating the parameter by using the gradient obtained after the noise addition.

5. A non-transitory computer-readable recording medium storing a program which causes a computer to function as the optimization apparatus according to claim 1.
